(19) United States
(12) Patent Application Publication
(10) Pub. No.: US 2021/0234149 A1
(43) Pub. Date: Jul. 29, 2021

(54) LITHIUM CELLS AND METHODS OF MAKING AND USE THEREOF

(71) Applicant: Tadiran Batteries Ltd., Kiryat Ekron (IL)

(72) Inventors: Herzel YAMIN, Ganei Yohanan (IL); Chen Menachem, Holon (IL); Zvi Yehuda Pomerantz, Petach-Tikva (IL)

(73) Assignee: Tadiran Batteries Ltd., Kiryat Ekron (IL)

(21) Appl. No.: 16/752,652

(22) Filed: Jan. 26, 2020

(51) Int. Cl. H01M 4/131; H01M 10/44; H01M 10/0525; H01M 4/1391; H01M 4/02

(52) U.S. Cl. CPC H01M 4/131; H01M 10/44; H01M 2004/027; H01M 4/1391; H01M 10/0525

(57) ABSTRACT

An electrochemical cell includes an anode including an anode material including silicon capable of reversibly incorporating lithium ions therein. The cell includes a cathode including an active cathode material capable of reversibly incorporating lithium ions therein. The cell includes a non-aqueous electrolyte solution in contact with the anode and the cathode. After the first charge and discharge cycle of the cell, when the cell is discharged to a voltage of 2.5 volt, the charge capacity due to the active lithium remaining incorporated in the anode active material is at least 20% of the total charge capacity obtained after charging the cell to a voltage of 4.1 volt. In the discharged state to 2.5 volt, the cathode active material is over-lithiated. The cathode material may have a formula of Li(M)O₂ where M may include one or more transition metals and may also include non-transition metal(s). Cell discharging is limited to 2.5 V.

### FIELD AND BACKGROUND OF THE INVENTION

The present invention, in some embodiments thereof, relates to rechargeable lithium electrochemical cells and more particularly, but not exclusively, to rechargeable lithium cells having over-lithiated cathodes.

Over the last two decades, Lithium-Ion cells have become the leading technology for rechargeable batteries. Presently, lithium-ion rechargeable cells are widely used for powering cell phones, laptops and many other portable electronic equipment. In addition, this technology is a leading candidate for ESS, smart grid and EV applications.

The chemistry of Lithium-ion cells is based on using lithium intercalation compounds whereas a matrix of certain crystalline compounds may serve as hosts for lithium ions. In the cathodes of such lithium-ion cells, lithiated oxides of transition metals in a general form of LiₓMO_{y} are widely used were M stands for nickel (Ni), cobalt (Co), manganese (Mn) or various different combinations of Ni, Co. and Mn. Sometimes, different metal types (such as, for example Al, Mg, Ca and others) are also included (in low percentages) in the cathode material serving as dopants stabilizing the crystal structure of the host cathodic material during extraction of lithium ions from the cathodic compounds.

In such lithium-ion cells, the anode may include carbon-based (carbonaceous) materials especially graphite, that may intercalate lithium in a general form of LiₓC_{y}. Lithium salts such as LiPF₆, Lithium Imides such as, for example, lithium bis(trifluoromethansulfonyl)imide (LiTFSI), LiBF₄ and/or other lithium salts, dissolved in mixtures of carbonate-based organic solvents such as EC, DEC, DMC, EMC, PC (see list of abbreviations below) are used as electrolytes in such lithium-ion cells.

Cathode materials containing lithium ions and lithium-free carbonaceous materials are used for cells preparation. During cell charging, lithium ions move from the cathode to the anode through the electrolyte and a microporous polyolefin membrane (usually made of PP, PE or combinations of PP and PE). During the discharge of the cell, lithium ions move back from the anode to the cathode.

During the first charging of the cell, when lithium ions are moved from the cathode to the anode, reduction of the electrolyte and precipitation of the reduction products on the surface of the carbon anode occurs to form a layer of solid electrolyte interphase (SEI) prior to the insertion of lithium ions into the depth of the carbon particles of the anode as described in an article by E. Peled, entitled “The Electrochemical Behavior of Alkali and Alkaline Earth Metals in Nonaqueous Battery Systems—The Solid Electrolyte Interphase Model” published in J. Electrochem. Soc., Vol 126, (No. 12) p. 2047 (1979).

A good SEI layer should have a high electrical resistance (to prevent further reaction of the electrolyte) and good conductivity for Lithium ions (to enable lithium ions to move through the SEI and into and out from the anode to the electrolyte). Another important parameter for a good SEI is flexibility to sustain strains formed due to volume changes of the anode particles during lithium ion intercalation and de-intercalation.

One of the most popular standard cells types used today is the 18650 cell. These cells have a capacity of up to 3.3 Ah with gravimetric energy density of up to 250 Wh/kg. These cells also have good power capabilities and can be useful for hundreds of charge/discharge cycles. However, optimization of the internal design of these cells (such as the use of low electrode porosity of about 20% and the use of a thin separator and thin current collectors having a thickness of about 12 μm), may increase the volume occupation of the active materials to above 70% of the cell volume which leaves limited space available for further capacity increase.

As such, the most promising way for achieving further capacity increases in Lithium ion cells is by using new materials with high specific capacity for lithium ions and a gravimetric density comparable to the gravimetric density of currently used materials.

For cathodes, high capacity materials such as, for example, lithium rich and/or nickel rich materials are currently widely investigated. These materials have specific capacities of more than 260 mAh/g, as compared to specific capacities of up to 170 mAh/g for cathode materials used today such as several types of nickel cobalt aluminum (NCA) materials or nickel manganese cobalt (NMC) materials. However, since the increase in capacity requires more active material in the cell's anode, such a 50% increase in specific capacity may practically result in only about a 20% increase in overall cell capacity.

Thus, in order to achieve a further increase of cell capacity and better utilization of the cathode material specific capacity a significant improvement in the anode charge capacity is required.

As of today, several high capacity materials are being investigated for use as anode materials, including, inter alia, tin (Sn), germanium (Ge) and silicon (Si). The most attractive material is Si which may accommodate up to 4.4 Li atoms per Si atom, which is equivalent to a specific capacity of 4.2 Ah/g. This is more than 10 times higher compared to the specific capacity of graphite (372 mAh/g).

However, there is a massive volume change of fully lithiated silicon of about 300% (as compared to the volume of non-lithiated Si) that prevents achievement of a high number of charge/discharge cycles of Si anode-based lithium ion cells, due to loss of electrical contacts upon continuous volume changes, and the continuous consumption of lithium ions to renew cracked or damaged SEI, and side reactions with the electrolyte.

Several approaches were described to enhance cyclability of such lithium ion cells with silicon based anodes and to overcome the failure mechanisms described above.

A first approach is the limitation of the silicon state of charge (SOC) in the anode. The use of a high silicon concentration anode leads to a lower Li+ ion concentration in each silicon particle for a given SOC. By lowering the degree of charge, the volume change of each silicon particle in the anode is reduced resulting in a reduction of the destructive internal processes and pulverization of the anode.

A second approach is described in an article by L. Y. Yang et al. entitled “Dual yolk-shell structure of carbon and silica-coated silicon for high-performance lithium-ion batteries”, published in Scientific Reports, 5:10908 (2015). This approach uses encapsulation of the silicon particles inside a core-shell structure by coating each silicon particle by a layer of a second material like polymer, graphite or carbon in order to reduce the swelling of the silicon particles upon lithiation/de-lithiation.

A third approach is described by Candace Chan et al., in an article entitled “High performance lithium battery anodes using silicon nanowires published in Nature Nanotechnology Vol 3 (issue 1), pp. 31-35 (2008). The article discloses the use of silicon nanowires or nanorods or other silicon nanoparticle shapes that direct the volume changes to non-destructive directions inside the anode matrix.

A fourth approach is disclosed by A. Magasinsky et al., in an article entitled “Toward efficient binders for Li-ion battery Si-based anodes: Polyacrylic acid”, published in ACS, Appl. Mater. Interfaces Vol 2 (issue 11) pp. 3004-3010 (2010). This approach uses elastic, high Young's modulus binders like polyacrylic acid, incorporated into the anode matrix instead of the widely used PVDF or CMC binder.

However, none of these approaches prevent the continuous deterioration of the silicon anode-based lithium ion cell and only a limited success was reported in enhancement of the charge/discharge stability of the system.

### SUMMARY OF THE INVENTION

There is therefore provided, in accordance with some embodiments of the cells of the present application, an electrochemical cell. The electrochemical cell includes an anode comprising an anode material including silicon capable of reversibly incorporating lithium ions therein. The cell also includes a cathode including an active cathode material capable of reversibly incorporating lithium ions therein. The cell also includes a non-aqueous electrolyte solution in contact with the anode and the cathode. After the first charge and discharge cycle of the cell, when the cell is discharged to a voltage of 2.5 volt, the charge capacity due to the active lithium remaining incorporated in the anode active material is at least 20% of the total charge capacity obtained after charging the cell to a voltage of 4.1 volt.

In some embodiments of the cell, the active cathode material includes a lithiated metal oxide of the formula LiₓMO₂, where X≥1.

In some embodiments of the cell, the cathode is electrochemically over-lithiated outside the cell prior to cell assembly.

In some embodiments of the cell, the cathode is made from chemically synthesized active over-lithiated lithium metal oxide having a formula LiₓMO₂, where X>1.2.

In some embodiments of the cell, M is selected from at least one transition metal or at least one transition metal and at least one other metal.

In some embodiments of the cell, the transition metal is selected from one or more of cobalt, nickel and manganese, and the other metal is selected from one or more of, aluminum, magnesium and calcium.

There is also provided in accordance with some embodiments of the methods of the present application, a method for constructing the rechargeable lithium ion cell. The method includes the steps of:

1) Providing an anode having an anode material including silicon capable of reversibly incorporating lithium ions therein.

2) Providing an over-lithiated cathode including an over-lithiated active cathode material capable of reversibly incorporating lithium ions therein. The active cathode material includes a lithiated metal oxide of the formula LiₓMO₂, where X>1.2.

3) Providing a non-aqueous electrolyte solution in contact with the anode and the cathode, and sealing the cell.

In some embodiments of the method, the over-lithiated cathode of the second step of providing is obtained by a step selected from:

1) Preparing the cathode from a chemically synthesized cathode material including a lithiated metal oxide of the formula LiₓMO₂, wherein X>1.2.

or

2) Electrochemically forming prior to assembling the cell, an over-lithiated cathode by electrochemically transferring to a cathode material of the formula Li₁MO₂ excess lithium such that it is overlithiated to a formula LiₓMO₂, where X>1.2.

There is also provided, in accordance with some embodiments of the methods of the present application a method for using the electrochemical cell. The method includes the steps of:

1) Providing a cell as disclosed hereinabove.

2) Charging the cell to a voltage of 4.1V; and

3) Discharging the cell to a limited voltage of 2.5 volt.

In some embodiments of the method, the method also includes the step of cycling the cell by repeating the steps of charging and discharging, while limiting the discharging to a voltage of 2.5V.

In some embodiments of the cells and methods of the present application, the cell cathode active material is NMC 622. In the over-lithiated state the cathode active material has the formula LiₓNi_{0.6}Mn_{0.2}Co_{0.2}O₂, where X>1.2.

In some embodiments of the cells and methods of the present application, the cell cathode active material is NMC 532. In the over-lithiated state the cathode active material has the formula LiₓNi_{0.5}Mn_{0.3}Co_{0.2}O₂, where X>1.2.

Finally, in some embodiments of the cells and methods of the present application, the cell cathode active material is NMC 811, In the over-lithiated state the cathode active material has the formula LiₓNi_{0.8}Mn_{0.1}Co_{0.1}O₂, where X>1.2.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention may involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

### BRIEF DESCRIPTION OF THE SEVERAL VIEWS OF THE DRAWINGS

Some embodiments of the invention are herein described, by way of example only, with reference to the accompanying drawings, in which like components are designated by like reference numerals. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic graph illustrating a cell's voltage of lithiated MP532 cathode potential (as measured against a lithium metal anode) during a process of cell discharge resulting in lithium intercalation within the cathode material of the cell;

FIG. 2 is a schematic graph illustrating the charge potential of an over lithiated NMC cathode (as measured against a lithium metal anode);

FIG. 3 which is a schematic graph representing the discharge capacity of the cell of EXAMPLE 1 subjected to charge/discharge cycles at a rate C/4;

FIG. 4 which is a schematic graph representing the discharge capacity of the cell of EXAMPLE 2 subjected to charge/discharge cycles at a rate of C/4 and at a discharge voltage limited to 3V;

FIG. 5, which is a schematic graph representing the discharge capacity of the cell of EXAMPLE 3 subjected to charge/discharge cycles at a rate of C/4 and a discharge voltage limited to 3V; and

FIG. 6 which is which is a schematic graph representing the discharge capacity of the cells of EXAMPLES 6 and 7 subjected to charge/discharge cycles at a rate of C/4 and a discharge voltage limited to 2.5V.

### DETAILED DESCRIPTION OF SPECIFIC EMBODIMENTS OF THE INVENTION

### Abbreviations

The following abbreviations are used throughout the present application:

| Abbreviation | Meaning |
|---|---|
| μm | micrometer |
| cm | centimeter |
| cm² | Square centimeter |
| DEC | Diethyl carbonate |
| DMC | Dimethyl carbonate |
| EMC | Ethyl methyl carbonate |
| EMF | Electromotive force |
| ESS | Energy storage system |
| EV | Electric vehicles |
| g | gram |
| Kg | Kilogram |
| L | Liter |
| Li | Metallic lithium |
| Li+ | Lithium ion |
| mA | milliampere |
| Ah | Ampere hour |
| mAh/g | Milliampere hour per gram |
| mm | millimeter |
| OCV | Open Cell Voltage |
| PAA | Polyacrylic acid |
| PC | Propylene carbonate |
| PTFE | Polytetrafluoroethylene |
| PVDF | Polyvinylidenefluoride |
| PP | Polypropylene |
| SEI | Solid electrolyte interphase |
| V | Volt |
| Wh | Watt hour |

The present application discloses a novel type of Lithium-ion rechargeable cells having a silicone based anode and an over-lithiated cathode material based on a incorporating excess lithium in active cathode material, such as, for example, lithiated transition metal oxides including but not limited to NMC type cathode materials or similar lithium/metal oxides. The novel cells have very good cell charge capacity and a good cyclability.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways. It is expected that during the life of a patent maturing from this application many relevant electrochemically suitable solid cathodes will be developed and the scope of the terms “solid cathode” and “solid cathode material” are intended to include all such new technologies a priori. As used herein the term “about” refers to ±10%. The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

The term “over-lithiated cathode material” means a lithium metal oxide active material having a generalized formula Li_{X}M_{Y}O₂ that has a lithium to metal molar ratio Li/M>1.0 in the discharged state. The term “over-lithiated cathode” means a cathode including an over-lithiated active cathode material.

It is noted that the metal M may be any combination of transition metals, such as for example, nickel, cobalt and manganese but may also include small amounts of other metals, such as, for example aluminum, magnesium, calcium or other metals.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The solvents described in the examples below were lithium battery grade materials obtained from BASF SE, Germany,

Various embodiments and aspects of the present invention as delineated hereinabove and as claimed in the claims section below find experimental support in the following examples.

It is well known that the number of charge/discharge cycles can be markedly increased by partial discharge cycles. At a discharge range of 4.2V to a 3.0V cutoff, the cell can deliver approximately 100 charge/discharge cycles. However, under partial discharge to a cutoff voltage of 3.2V at least 200 cycles can be obtained prior to degradation of cell capacity to 70% of the initial value. One possible reason for the significant increase of the cycle numbers by partial discharge may be attributed to the better built up and repair mechanism of the SEI (Solid electrolyte Interphase) at the lithiation degree of the silicon anode.

As stated above, the volume change during charge and discharge cycles cracks or damages the SEI of the anode and the electrolyte starts to penetrate through the cracks and reacts with the lithiated anode to form non reversible reaction products such as Li₂CO₃. Formation of this product in the vicinity of the cracks may practically stop the penetration of the electrolyte into the Si material of the anode and may stop or reduce the charge loss.

When the lithiation degree of anodic Si is relatively low, the reaction rate of the solvent with the lithiated Si anode is relatively slow and more electrolyte may penetrate through the cracks in the SEI before their blocking by the reaction products. Therefore, it has occurred to the inventors of the present invention that it may be possible to solve the above described problems by increasing the degree of lithiation of the anode material close to the end of the cell's discharge.

One possible method to achieve this is to attach lithium metal to the anode of the cell during cell assembly. This may be done by placing a lithium metal foil in direct contact with the anode or in contact with the case of the negative pole of the cell. Lithium will then penetrate into the Si spontaneously after filling the cell with the electrolyte due to the difference in the electrochemical voltage between the lithium metal and the Si anode.

In another embodiment of this invention, it is possible to increase the amount of lithium in the raw material powder of the cathode. This method is referred to as “over lithiation”, hereinafter. This excess of lithium in the cell's cathode may be used to further lithiate the Si anode upon charging of the cell.

In raw materials used in lithium ion cell's cathodes, the typical molar ratio of lithium to the sum of the transition metals (TM) is one, with the general formula LiNiₓMn_{y}Co_{z}O₂ (X+Y+Z=1). For example, for the cathode material NMC 622 the chemical formula is LiNi_{0.6}Mn_{0.2}Co_{0.2}O₂ while for the cathode material NMC 811 the chemical formula is LiNi_{0.8}Mn_{0.1}Co_{0.1}O₂.

It is noted that when X=Y=0 the chemical formula of the cathode material is LiCoO₂. Upon charging of the lithium ion cell, lithium ions move from the cathode and are intercalated in the anode. The cathode potential starts at about 3.3 volt in its discharged state (compared to the standard lithium potential) and increases during the charging step to 4.1 volt (compared to the standard lithium potential) for a fully charged cathode. It was found that the cathode raw material can be further lithiated to a formula of Li_{1.5}MO₂. This may be done chemically by appropriate synthesis of suitable over-lithiated cathode materials or, alternatively by electrochemical transfer of lithium ion in appropriate solutions.

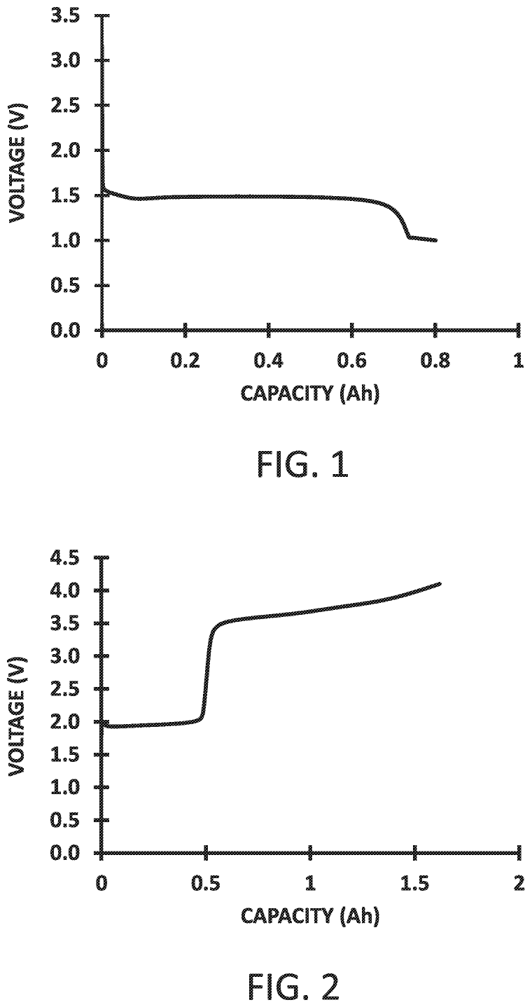

Reference is now made to FIG. 1 which is a schematic graph illustrating a cell's voltage of lithiated NMC532 cathode potential (as measured against a lithium metal anode) during a process of cell discharge resulting in lithium intercalation within the cathode material of the cell. In FIG. 1, the vertical axis of represents the cathode potential (in Volt) and the horizontal axis represents the cell's capacity in Ah.

When a cell is assembled having metallic lithium at the anode and lithiated NMC532 at the cathode and the cell is allowed to discharge, lithium ions are transferred from the anode (passing through the electrolyte solution of the cell) to the cathode and enter into the lithiated NMC532 material to form an over-lithiated cathode material at the cathode. As may be seen from the graph of FIG. 1 the plateau voltage is about 1.5 volt.

If the over-lithiated cathode is taken out of the cell of FIG. 1 and combined in a new cell with a metallic lithium anode and the same solvent/electrolyte mixture used in the cell of FIG. 1, the new cell when charged by transferring lithium ions from the overlithiated cathode to the anode of the cell.

Reference is now made to FIG. 2 which is a schematic graph illustrating the charge potential of an over lithiated NMC cathode (as measured against a lithium metal anode). The vertical axis represents the voltage (in Volt) and the horizontal axis represents the cell's capacity in Ah. As may be seen from the graph of FIG. 2 the total charge that is delivered during the charging step at a charging voltage of 2.0V is about one half of the total charge delivered by charging to a voltage of 4.1 volt. Therefore, the estimated formula of the over-lithiated active cathode material at the end of this charging step is assumed to be Li_{1.5}N_{0.5}Mn_{0.3}Co_{0.2}O₂. Upon further charge/discharge cycles, the over-lithiated NMC532 was found to be very reversible and very stable in air.

However, this electrochemical process of overlithiation is not obligatory, and it is also possible to form such over-lithiated cathode materials by chemical synthesis of the overlithiated cathode materials. Such over-lithiated cathodes may then be used together with silicone based anodes to form the novel lithium ion cells of the present invention.

Cell Preparation Method

The over lithiated cathode raw material was chemically synthesized from hydroxide precursors using the method described by Jing Li et al. in an article entitled “Structural and electrochemical study of the Li—Mn—Ni oxide system within the layered single phase region” published in Chem. mater. Vol. 26, (24) pp. 7059-7066 (2014). The dried precursors were mixed with a stoichiometric equivalent of Li₂CO₃.

Samples with lithium to transition metal molar (Li/TM) ratio of 1.5 were mixed and sintered in a high temperature furnace, followed by grinding, sieving, washing and drying, to remove excess of Li₂CO₃ residue. The synthesized over lithiated NMC material was mixed with polyvinylidene di fluoride (PVDF) and carbon black using N-Methyl-2-pyrrolidone (NMP) as a solvent. The resulting slurry was used to coat both sides of an aluminum current collector followed by calendaring and curing in a drying room.

The anodes were prepared from Si powder, carbon black and a polyacrylic acid (PAA) binder in a water-based slurry. The slurry was used to coat both sides of a copper foil followed by drying and calendaring. The AA size lithium cells were assembled in a dry room and filled with a solution of LiPF₆ electrolyte in a EC:DMC:DEC mixture (1:1:1 by volume). After cell formation and first discharge, the cells were charged and discharged at various continuous currents. More than 1000 charge discharge cycles were obtained before cell capacity dropped to 70% of its initial value.

### EXAMPLES

Reference is now made to the following examples, which together with the above descriptions illustrate some embodiments of the invention in a non limiting fashion.

### Example 1

### Preparation of the Anode

The anode active material was prepared by adding silicon powder having a silicon particle size in the range of 1-2 μm, to a water solution of lithium polyacrylic acid salt (LiPAA, MW=450 k) followed by adding graphite and carbon. The ratio of the materials in the anode was 70% silicon, 7% LiPAA binder and 23% carbon and graphite. The slurry is mixed at room temperature in an open-air atmosphere for two hours. The slurry was then spread on a 10 μm thick copper foil by the doctor blade method, dried for 30 min at 60° C. and calendared in a roll to roll press. Prior to insertion into the cell, the anode was dried overnight in an argon atmosphere at 110° C.

### Preparation of the Cathode

The cathode active material was prepared by dissolving polyvinylidene fluoride (PVDF) in N-Methyl-2-pyrrolidone followed by adding lithium nickel cobalt aluminum oxide (NCA) material (having the formula LiNi_{0.8}Co_{0.15}Al_{0.05}O₂), graphite and carbon to the solution. The ratio of the materials in the cathode was 87% NCA, 3% PVDF and 10% carbon and graphite. The slurry was mixed at room temperature in an open-air atmosphere for one hour. The slurry was spread on both sides of a 19 μm thick aluminum foil by the doctor blade method, dried for 30 min at 80° C. and calendared in a roll to roll press. Prior to insertion into the cell the cathode was dried overnight in an argon atmosphere at 110° C.

### Preparation of Lithium Ion Battery

The anode and the cathode foils were cut to a 4 cm width and rolled with a 25 μm, 50% porous, polypropylene separator to form a cell core having a diameter of about 0.65 cm. The core was inserted into a 1550 size nickel plated cold rolled steel can. A cell cover was laser welded to the can and the cell was filled with about 3.0 g of an electrolyte solution containing 1M LiPF₆ electrolyte in a solvent mixture of Ethylene carbonate, diethyl carbonate, dimethyl carbonate (EC:DEC:DMC 1:1:1 by volume), followed by welding of the solvent filling hole for hermetically closing of the cell. The rolling of the cell core, the cell assembly, welding, solvent filling and sealing were performed are done in a −40° C. dew point dry room.

### Cell Charging and Discharging

Charging of the cell was performed using a constant current and constant voltage method (CCCV) at a current density of 0.4 mA/cm² (130 mA) to a voltage of 4.1V followed by constant voltage of 4.1V until the charging current decreased to 20 mA. The charging process takes eight hours and the charge capacity reached is 1050 mAh. Discharging the cell at a low rate of C/20 yielded a reversible capacity of 900 mAh. The irreversible capacity is therefore about 15%. At higher cell discharge rates of C/4, 1C and 4C the reversible capacities were 870 mAh, 820 mAh and 810 mAh, respectively.

### Charge/Discharge Cycles

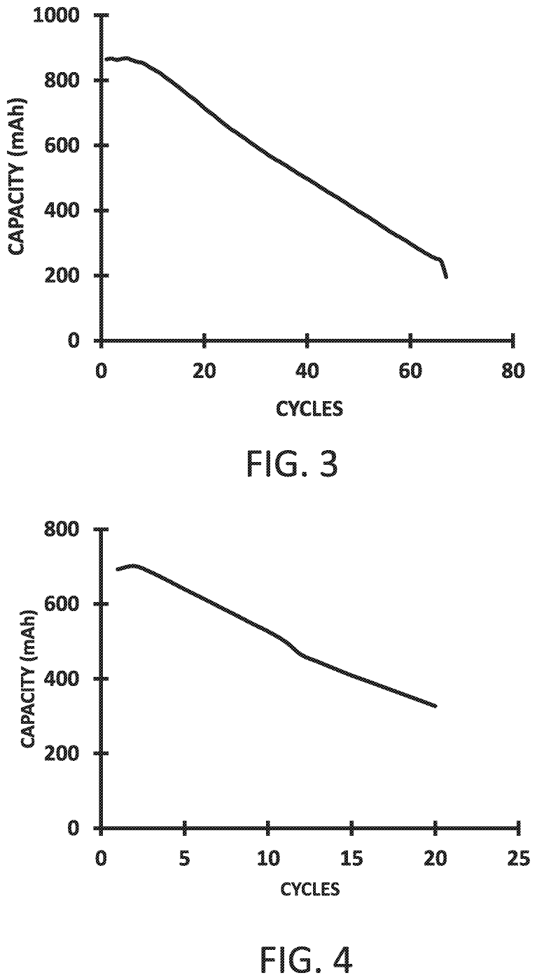

Reference is now made to FIG. 3 which is a schematic graph representing the discharge capacity of the cell of EXAMPLE 1 subjected to charge/discharge cycles at a rate C/4. The vertical axis of the graph of FIG. 3 represents the cell capacity (in mAh) and the horizontal axis represents the number of charge/discharge cycles. Charge/discharge cycles were performed at a rate of C/4 using the CCCV method at a cell voltage range of 4.1V-2.5V. Under these conditions it takes about 20 charge/discharge cycles to lose 20% of the cell's initial capacity (an average loss of 1% cell capacity/cycle).

### Example 2

The preparation of the electrodes and of the lithium ion cells were as described for the cells of EXAMPLE 1, with the exception that lithium nickel manganese cobalt oxide (NMC) 532 was used in the cathode slurry instead of NCA. It is noted that in EXAMPLE 2 the cathode active material was not over-lithiated. The cell first charge and charge discharge cycles were performed as described in EXAMPLE 1.

Reference is now made to FIG. 4 which is a schematic graph representing the discharge capacity of the cell of EXAMPLE 2 subjected to charge/discharge cycles at a rate of C/4. The vertical axis of the graph of FIG. 4 represents the cell capacity (in mAh) and the horizontal axis represents the number of charge/discharge cycles. As may be seen in FIG. 4, the capacity of the cell at first charge was 870 mAh. At a rate of C/4 the cell's capacity was 700 mAh and in charge/discharge cycles at a rate of C/4 the cell reached 80% of the initial cell capacity after 8 cycles.

### Example 3

The preparation of the electrodes and of the lithium ion cells were as described for the cells of EXAMPLE 1. The cell first charge and charge/discharge cycles were performed as described in EXAMPLE 1 above, with the exception that the voltage range of charge/discharge cycles are 4.1V to 3.0V (instead of the 4.1V to 2.5V range used in EXAMPLE 1).

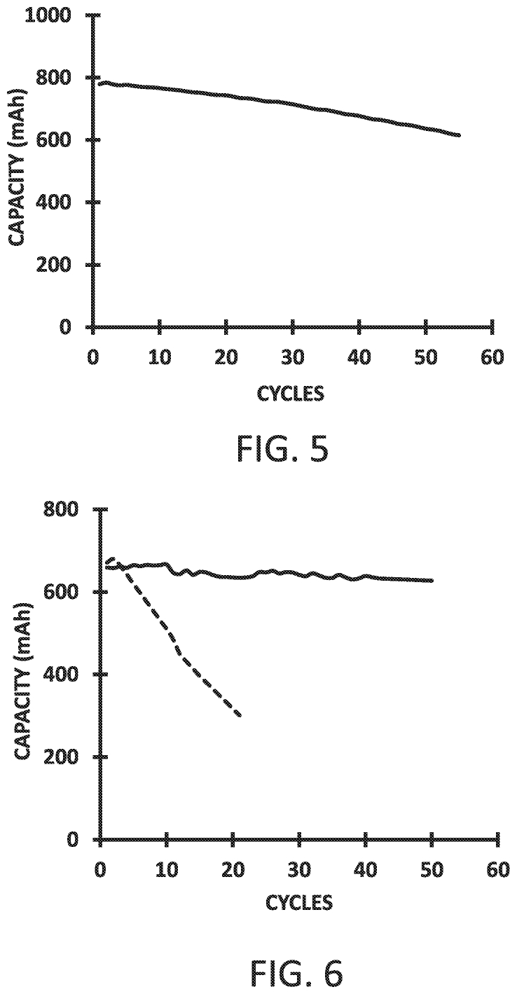

Reference is now made to FIG. 5, which is a schematic graph representing the discharge capacity of the cell of EXAMPLE 3 subjected to charge/discharge cycles at a rate of C/4 and at a discharge voltage limited to 3V. The vertical axis of the graph of FIG. 4 represents the cell capacity (in mAh) and the horizontal axis represents the number of charge/discharge cycles.

As may be seen in the graph of FIG. 5, limiting of the discharge voltage to 3.0V results in a significantly higher stability of the cell during charge/discharge cycles and the cell loses 20% of its initial cell capacity only after about 50 charge/discharge cycles (as compared to 8 cycles in the cells of EXAMPLE 2).

### Example 4

The preparation of the electrodes and of the lithium ion cells were as described for the cells of EXAMPLE 1, with the exception that lithium nickel manganese cobalt oxide (NMC) 811 is used in the cathode slurry instead of the lithiated NCA material of EXAMPLE 1. For this cell the first charge capacity to a voltage of 4.1V was 1500 mAh and the discharge capacity at C/4 was 1350 mAh. At a charge/discharge rate of C/4, the cell delivered 35 cycles before cell capacity decreased to 70% of the cell initial capacity. This example therefore demonstrates that cathode materials different than the lithiated NCA material of EXAMPLE 1 may be used and may also be over-lithiated.

### Example 5

### Electrochemical Formation of Overlithiated Cathode

A cell similar to the cell described in EXAMPLE 2 was made in which the silicon anode (of EXAMPLE 2) was replaced with a lithium foil having a thickness 70 mμ. The open cell voltage (OCV) of the cell was 3.2V. The cell was discharged down to a voltage of 1V at a discharge current of 50 mA (see FIG. 1). The obtained capacity was 800 mAh. Most of this capacity was obtained at a voltage plateau of 1.5V. This capacity corresponds to about 154 mAh/g NMC (0.58 equivalent lithium). At the end of the discharge process, the cathode was charged with excess lithium (over-lithiated) to form Li_{1.58}(NMC 5:3:2)O₂ from the initially used Li₁(NMC 5:3:2)O₂. At this stage, the cell was charged to 4.1V yielding a cell capacity of 1600 mAh. Of this cell capacity, 500 mAh were obtained at a low voltage plateau of about 2V. The rest of the cell capacity was obtained at voltage above 3.3V. The cell was discharged again to 3.3V. The obtained capacity in this discharge was 710 mAh (0.52 equivalent lithium).

This example demonstrates that a lithiated NMC cathode can be over-lithiated significantly by an electrochemical step. This extra lithiation was found to be highly reversible without damaging the cathode, resulting in a cell exhibiting a relatively small overall capacity loss of 100 mAh and high reversible discharge capacity (710 mAh, 136 mAh/g NMC).

### Example 6

Cells similar to the cell described in EXAMPLE 5 were assembled and were discharged under conditions similar to the discharge conditions described in EXAMPLE 5. After a 800 mAh discharge, the cells were cut open and the cathodes of the cells were used for assembling new fresh cells with fresh electrolyte separator and Si based anodes prepared as described in detail in EXAMPLE 2. The cells were charged to 4.1V giving a cell capacity of about 1600 mAh. About 400 mAh were obtained at a voltage plateau of 2.1V. The rest of the capacity was obtained at a voltage of above 3V. The cells were cycled between 2.5V to 4.1V with initial capacity of about 660 mAh. After 50 charge/discharge cycles, the cell capacity was decreased to 630 mAh only (4.5%/50 cycles. or 0.09%/cycle capacity loss).

### Example 7

For comparison, cells with the same structure and composition as in EXAMPLE 6 were made, except that the cell cathodes were not pre-processed for over-lithiation and the cathodes of the cells consisted of non-over-lithiated lithium nickel manganese cobalt oxide (NMC) 532. The cells were charge/discharge cycled under the same conditions of the cells of EXAMPLE 6. Charge capacity for these cells was about 880 mAh and discharge capacity was 680 mAh. After 20 charge/discharge cycles, the cell's discharge capacity linearly decreased to 300 mAh only (a capacity loss of 56%/20 cycles. or 2.8%/cycle).

Reference is now made to FIG. 6 which is a schematic graph representing the discharge capacity of the cells of EXAMPLES 6 and 7 subjected to charge/discharge cycles at a rate of C/4 and a discharge voltage limited to 2.5V. The vertical axis of the graph of FIG. 6 represents the cell capacity (in mAh) and the horizontal axis represents the number of charge/discharge cycles. The solid curve represents the discharge capacity of a cell of EXAMPLE 6 and the dashed curve represents the discharge capacity of a cells of EXAMPLE 7. As may be seen, the stability of cell charge capacity of EXAMPLE 6 (having an electrochemically over-lithiated cathode active material) during charge/discharge cycling is much improved as compared to the cell of EXAMPLE 7 in which the cathode active material was not over-lithiated prior to cell assembly.

### Example 8

Cells similar to the cells described in EXAMPLE 6 were assembled, except that the over-lithiation of the cathode was performed by chemical synthesis of over-lithiated NMC cathode material from NMC 5:3:2 (LiNi_{0.5}Mn_{0.3}Co_{0.2}O₂) and Li₂CO₃ as described in detail hereinabove. The cells were charged to 4.1V at a current of 50 mA. The resulting cell charge capacity was 1640 mAh and the first discharge capacity to 2.5V was 720 mAh.

The cells were cycled between 2.5V to 4.1V, as described in EXAMPLE 6. After 80 charge/discharge cycles, the cell capacity was decreased to 685 mAh. This value indicated a capacity loss of approximately only 0.06%/cycle.

It is noted that the type of electrolyte solutions described in the examples hereinabove are not to be regarded as obligatory to practicing the cells of the present invention. It may be possible to use different ionizable salts and/or different types of organic solvents (or solvent mixtures) as long as they are compatible with the chemistry of the cathode materials and the silicone anode material solid cathode being used in the cell.

Furthermore, it is noted that although the experimental cells described in EXAMPLES 1-8 above were constructed as a “Jelly Roll” type cell, this is not obligatory to practicing the invention and any other suitable type of cell structure may be used. For example, button type, wafer type, prismatic type and bobbin type lithium ion cells may all be constructed and are included within the scope of the lithium-ion cells of the present invention. Any other type of cell construction and/or any size of such cells may be used as long as it is compatible with the cell's ingredients.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An electrochemical cell comprising:
an anode comprising an anode material comprising silicon capable of reversibly incorporating lithium ions therein;
a cathode comprising an active cathode material capable of reversibly incorporating lithium ions therein;
a separator disposed between the anode and the cathode; and
a non-aqueous electrolyte solution in contact with the anode and the cathode,
wherein after a first charge and discharge cycle of the cell, when the cell is discharged to a voltage of 2.5 volt, the charge capacity due to the active lithium remaining incorporated in the anode active material is at least 20% of the total charge capacity obtained after charging the cell to a voltage of 4.1 volt.

2. The cell according to claim 1, wherein the active cathode material comprises a lithiated metal oxide of the formula LiₓMO₂, where X≥1.

3. The cell according to claim 1, wherein the cathode is electrochemically over-lithiated outside the cell prior to cell assembly.

4. The cell according to claim 1, wherein the cathode is made from chemically synthesized active over-lithiated lithium metal oxide having a formula LiₓMO₂, where X>1.2.

5. The cell according to claim 2, wherein the M is selected from the list consisting of,
at least one transition metal, and
at least one transition metal and at least one other metal.

6. The cell according to claim 5, wherein the at least one transition metal is selected from one or more of cobalt, nickel and manganese, and wherein the at least one other metal is selected from one or more of, aluminum, magnesium and calcium.

7. The cell according to claim 1, wherein the cell cathode active material is NMC 622, and wherein in the over-lithiated state the cathode active material has the formula LiₓNi_{0.6}Mn_{0.2}Co_{0.2}O₂, where X>1.2.

8. The cell according to claim 1, wherein the cell cathode active material is NMC 532, and wherein in the over-lithiated state the cathode active material has the formula LiₓNi_{0.5}Mn_{0.3}Co_{0.2}O₂, where X>1.2.

9. The cell according to claim 1, wherein the cell cathode active material is NMC 811, and wherein in the over-lithiated state the cathode active material has the formula LiₓNi_{0.8}Mn_{0.1}Co_{0.1}O₂, where X>1.2.

10. A method for constructing a rechargeable lithium ion cell according to claim 1, the method comprises the steps of,
providing an anode having an anode material comprising silicon capable of reversibly incorporating lithium ions therein;
providing an over-lithiated cathode comprising an over-lithiated active cathode material capable of reversibly incorporating lithium ions therein, the active cathode material comprises a lithiated metal oxide of the formula Li_{X}MO₂, wherein X>1.2; providing a separator disposed between the anode and the cathode; and
providing a non-aqueous electrolyte solution in contact with the anode and the cathode and sealing the cell.

11. The method according to claim 10, wherein the over-lithiated cathode of the second step of providing is obtained by a step selected from,
preparing the cathode from a chemically synthesized cathode material including a lithiated metal oxide of the formula LiₓMO₂, where X>1.2, and
electrochemically forming prior to assembling the cell, an over-lithiated cathode by electrochemically transferring to a cathode material of the formula Li₁MO₂ excess lithium such that it is overlithiated to a formula LiₓMO₂, where X>1.2.

12. The method according to claim 10, wherein the cell cathode active material is NMC 622, and wherein in the over-lithiated state the cathode active material has the formula LiₓNi_{0.6}Mn_{0.2}Co_{0.2}O₂, where X>1.2.

13. The method according to claim 10, wherein the cell cathode active material is NMC 532 of and wherein in the over-lithiated state the cathode active material has the formula LiₓNi_{0.5}Mn_{0.3}Co_{0.2}O₂, where X>1.2.

14. The method according to claim 10, wherein the cell cathode active material is NMC 811 and wherein in the over-lithiated state the cathode active material has the formula LiₓNi_{0.8}Mn_{0.1}Co_{0.1}O₂, where X>1.2.

15. A method for using a rechargeable cell according to claim 1, the method comprises the steps of,
providing a cell according to claim 1;
charging the cell to a voltage of 4.1V; and
discharging the cell to a limited voltage of 2.5 volt.

16. The method according to claim 15, wherein the method also includes the step of cycling the cell by repeating the steps of charging and discharging, while limiting the discharging to a voltage of 2.5V.

17. The method according to claim 15, wherein the cell cathode active material is NMC 622, and wherein in the over-lithiated state the cathode active material has the formula LiₓNi_{0.6}Mn_{0.2}Co_{0.2}O₂, where X>1.2.

18. The method according to claim 15, wherein the cell cathode active material is NMC 532 of and wherein in the over-lithiated state the cathode active material has the formula LiₓNi_{0.5}Mn_{0.3}Co_{0.2}O₂, where X>1.2.

19. The method according to claim 15, wherein the cell cathode active material is NMC 811 and wherein in the over-lithiated state the cathode active material has the formula LiₓNi_{0.8}Mn_{0.1}Co_{0.1}O₂, where X>1.2.

20. The electrochemical cell according to claim 1, wherein the non-aqueous electrolyte solution comprises 1M LiPF₆ electrolyte in a solvent mixture of ethylene carbonate (EC), diethyl carbonate (DEC) and dimethyl carbonate (DMC), 1:1:1 by volume, and wherein the separator comprises a microporous polyolefin membrane selected from the list consisting of microporous polypropilenes (PP), microporous polyethilenne (PE) and any combination thereof.
